(19) United States
(12) Patent Application Publication
(10) Pub. No.: US 2024/0220679 A1
(43) Pub. Date: Jul. 4, 2024

(54) SPARSE AND NON CONGRUENT STOCHASTIC ROLL-UP

(71) Applicant: Sam B. Savage, Palo Alto, CA (US)

(72) Inventor: Sam B. Savage, Palo Alto, CA (US)

(21) Appl. No.: 18/412,313

(22) Filed: Jan. 12, 2024

Related U.S. Application Data
(63) Continuation of application No. 17/727,629, filed on Apr. 22, 2022.
Application No. 17/727,629 is a continuation of application No. 15/494,431, filed on Apr. 21, 2017, now abandoned.
(60) Provisional application No. 62/325,931, filed on Apr. 21, 2016.

(51) Int. Cl. G06F 30/20; G06F 111/08; G06Q 10/0635; G06Q 50/26

(52) U.S. Cl. CPC G06F 30/20; G06F 2111/08; G06Q 10/0635; G06Q 50/265

(57) ABSTRACT

When storing the results of a very large number of stochastic simulation trials of rare events, the amount of data involved may be prohibitive. Sparse and Non-Congruent Stochastic Roll-up are methods for decomposing and storing the results from Monte Carlo simulations such that the data stored only reflects the trials on which a risk event occurred, or focuses attention on some trials over other trials. When the need arises to view or calculate with the fully expressed data set, the results may be aggregated while maintaining statistical relationships between the components of the simulation.

### PRIORITY CLAIM

This application is a continuation of U.S. Patent Application Ser. No. 17/727,629 filed Apr. 22, 2022, which is a continuation of U.S. patent application Ser. No. 15/494,431 filed Apr. 21, 2017, which application claims priority to U.S. Provisional Patent Application Ser. No. 62/325,931 filed Apr. 21, 2016, both of which are incorporated by reference in their entireties as if fully set forth herein.

### COPYRIGHT NOTICE

This disclosure is protected under United States and/or International Copyright Laws. @2017 Sam Savage. All Rights Reserved. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyrights whatsoever.

### FIELD OF THE DISCLOSURE

The present disclosure relates to stochastic simulation.

### BACKGROUND

Stochastic simulation is the imitation of random processes used to gain insight into the behavior or distribution of outcomes of the processes. The Monte Carlo method of simulation uses repeated random sampling to give numerical results. Monte Carlo is frequently used when analytical solutions would be too difficult, too time consuming, or impossible, to compute. Simulation is often used to estimate the risks or rewards (henceforth referred to as “outcomes”) facing an organization along the dimensions of finance, safety, reliability and so on. However, when large numbers of simulations involving large numbers of calculations are performed, current methods may present various shortcomings, including requiring too many processing resources, taking too much time to perform the calculations, etc. Accordingly, improvements can be made to current stochastic simulation techniques.

### BRIEF DESCRIPTION OF THE DRAWINGS

Preferred and alternative examples of the present disclosure are described in detail below with reference to the following drawings:

FIGS. 1A, 1B, and 1C illustrate a non-sparse view of the Monte Carlo trials for 100,000 hypothetical infrastructure entities, each simulated with 10,000 trials.

FIG. 2 is a sparse SIP of an earthquake event. The Earthquake SIP in sparse notation has six elements rather than 10,000 in conventional notation as shown in FIG. 1.

FIG. 3 is the sparse SIPs for the infrastructural entities shown in FIG. 1. Each entity now has many fewer trials of data stored than in its non-sparse SIP from FIG. 1.

FIG. 4 is the Sparse Risk Database across all of the assets within the simulation, indexed by Monte Carlo trial and containing metadata about the asset, in this case location.

FIG. 5 is the sparse risk roll-up SIP across all assets.

FIGS. 6A and 6B show a sparse roll-up of impact with respect to specified asset category or classification chosen.

FIG. 7 shows the sparse roll-up of impact for any risk category chosen.

FIG. 8 is the tree representing four mutually exclusive outcomes and associated probabilities for a flood, earthquake, both, or neither.

FIG. 9 displays the total number of trials, nonzero trials, zero trials, and database size for Cases A, B, C, and D.

FIG. 10 displays the Simulation results for Cases A, B, C, and D, including Database Elements, Trial Number, and Impact.

FIG. 11 displays the Chance Weight per trial for Cases A, B, C, and D, as well as the weight for the Zero element.

FIG. 12 displays the final SIP with Cases A, B, C, and D and their associated trials and impacts concatenated with the Zero element.

FIG. 13 displays a system for simulating the projected outcomes resulting from changing the assets in a portfolio.

FIG. 14 demonstrates a hypothetical risk dashboard with mitigations based on Sparse Stochastic Roll-up.

FIGS. 15A, 15B, and 15C illustrate example displays of a Sparse SIP Library in the Microsoft PowerPivot environment.

FIG. 16 shows a sparse SIP Library in Microsoft Excel compatible with the open SIPmath™ standard.

FIG. 17 illustrates a flowchart of an example method for generating and storing trials of a stochastic simulation in a database.

FIG. 18 illustrates a flowchart of an example method for generating only those trials on which a significant event occurs and storing them in a database.

FIG. 19 illustrates a flowchart of an example method for generating trials of a stochastic simulation conditioned on external events.

FIG. 20 illustrates another flowchart of an example method for generating trials of a stochastic simulation conditioned on external events.

### DETAILED DESCRIPTION

In the discipline of probability management, the results of stochastic simulations are represented as arrays of simulation outcomes, commonly referred to as Stochastic Information Packets (SIPs). If the output SIPs of two or more stochastic simulations preserve the statistical relationships between the two or more simulations, they are said to be coherent, and comprise a Stochastic Library Unit with Relationships Preserved (SLURP). If two or more SIPs are Coherent, they may be used in vector calculations to aggregate the results of multiple simulations. For example, a set of coherent SIPs representing the uncertain financial outcomes of a portfolio of petroleum exploration projects could be added together to create a SIP of the uncertain financial outcomes of the portfolio as a whole, such as described in Probability Management, Sam Savage, Stefan Scholtes and Daniel Zweidler. OR/MS Today, February 2006, Volume 33, Number 1, the entire contents of which are herein incorporated by reference in their entirety.

In one example, a simulation involving risks across multiple assets or entities, perhaps thousands, such as the roads, bridges, and tunnels of a highway infrastructure may require millions of trials per asset to model rare events. In most cases, in order to be more useful, the simulation must capture the statistical relationships between elements. That is, all roads within, for example, a given seismic fault must be modeled to suffer similar damage simultaneously in the event of a local earthquake. In the past, to capture this relationship, all the elements needed to be present in the same simulation model. Recently, the discipline of probability management has evolved around storing simulation trials as vectors of realizations called Stochastic Information Packets (SIPs), which allow simulations to be decomposed into sub-simulations, whose trials are stored in a stochastic information system database. Techniques related to using SIPs are described, for example, in US Patent Publication No. 2009/0177611, U.S. Pat. Nos. 8,463,732, and 8,255,332B1, the contents of which are hereby incorporated by reference in their entirety.

The results in the stochastic information system database may subsequently be aggregated (rolled up) to compute total risk within any category across any part of the system, e.g. the safety risk across all assets in the north or the reliability across all bridges, or the risks across the entire system.

Two or more SIPs are said to be congruent if they are comprised of the same number of data elements and the corresponding elements on the two or more SIPs have the same likelihood of occurrence. Typically, the data elements of a SIP are assumed to be equally likely, with probabilities that sum to 1. For example, the trials of a SIP representing 1,000 financial outcomes of a petroleum exploration site would each be assumed to have one chance in 1,000 of occurring. Non-congruent SIPs might have different numbers of trials and different chances of occurring per trial. A class of non-congruent SIPs, referred to as Sparse SIPs, contain values for only certain simulation trials.

When a large set of entities are being simulated with many trials, the stochastic information system database can become too cumbersome to manage. Sparse SIPs address this problem by recording and storing only events that meet specified criteria (henceforth known as “significant events”). These criteria are typically specified by the designers of the simulation model.

In one aspect of the described systems and techniques, important criteria would be low probability and of notable consequence. Examples of such criteria include the failure of a major highway infrastructure asset, or the bankruptcy of a financial institution. On the trials in which there are no risk events, no results are stored. To perform aggregation, the results are selectively drawn from the database while preserving statistical relationships between outputs and entities.

The described techniques provide a method for creating, storing, and aggregating sparse and non-congruent SIPs, which may have different numbers of outcomes with likelihoods, which may sum to less than 1. This is beneficial when simulating rare adverse events.

### Problems Addressed by the Present Disclosure

In many sorts of simulations, it is useful to be able to examine low probability events that meet specified criteria, involving such things such as personal injuries, financial insolvencies of businesses, or the failures of military missions. The present disclosure provides systems and methods for incorporating significant events into simulations. The described systems and methods may be particularly beneficial in large simulations involving multiple entities, which may be decomposed into sub simulations according to the principles of probability management.

In one example, a simulation may contain multiple entities, such as the elements of a highway system infrastructure (bridges, highways, tunnels etc.). These entities are typically subject to two types of uncertainties. The first type of uncertainty includes Local or Idiosyncratic uncertainties, which are exemplified by the rate at which a specified road will deteriorate or a specified bridge will corrode over time. The second type of uncertainty includes Global, or External uncertainties, which impact multiple entities at once, and are exemplified by earthquakes or floods.

A number of applications for the described systems and methods are described below:

### Aggregating Risks for Financial Institutions

A first application of the described techniques is to model risk involving financial institutions, such as banks. The entities involved include the financial institutions. Sub entities may be defined as the lines of business and the individual accounts within the institutions.

In this example, the described techniques may be used to model five financial institutions, each with 50 lines of business, and each line of business containing 400 individual accounts. This totals to 100,000 individual accounts to be modeled and aggregated. In one example, the simulation may be set to run 10,000 trials to capture rare market events. In a traditional simulation, this would necessitate the storage and computation of 1 billion trials. The described techniques enable the practical management of this data.

The dimensions of risk may involve financial insolvency, regulatory violations, and reputational risk. Local uncertainties may include events such as major businesses leaving the area, customer fraud, or local security breaches. Global uncertainties may include financial conditions such as GDP, or the fluctuation of interest rates and unemployment. This application could be expanded to apply to systematic risk across various aspects of the financial industry.

### Aggregating Risks for National Defense Systems

Another application of the described techniques is modeling the risks of a national defense system. An example scenario would involve military assets pitted against opposing military forces, which may involve the risks of losing hardware assets, losing personnel, and losing strategic advantage.

This example is a scenario in which opposing forces face each other. The entities could consist of army divisions, brigades, and platoons; naval fleets, task groups, and individual vessels; or air force wings, squadrons, and individual aircraft.

A local uncertainty for this example may be the actual performance of one's own assets, which may vary significantly based on the circumstances of the asset's deployment and use. For example, two opposing units of known strength could still result in many different outcomes due to chance.

For this example, global uncertainties that affect national defense may include weather, jamming of GPS across assets, or a cyber-attack aimed at taking networked assets out of commission, affecting command and control.

### Aggregating Risk Across Highway Infrastructure Systems

In a third application of the described techniques, a government agency may plan to assess and mitigate the risk of its infrastructural assets. A typical highway infrastructure system is composed of multiple classifications of entities, such as highways, bridges, and tunnels. Each of these entities may be subject to different risk events, from low-impact but relatively common minor events, to high-impact, low-probability catastrophic events. The risks may have multiple impact dimensions, for example, the safety risk of a pothole on the highway or the reliability risk of corrosion on a bridge leading to closure.

In this example involving highway infrastructure, the local uncertainties may affect individual assets, and may include potholes on roads and corrosion on bridges. The global uncertainties may affect many assets on trials where they occur, and may include events such as earthquakes or floods.

For example, a highway system may include 100,000 road segments, bridges and tunnels, each of which has roughly one chance in 1,000 of a serious maintenance failure with associated damage costs in the coming year. Assume that 10,000 trials are run to assure that roughly ten failures per entity are simulated. This would require 100.000 SIPs of 10,000 elements each for a total of 1 billion numbers. Although this is not a prohibitive number by current computing standards, the amount of data makes the data cumbersome to manage, and impractical to perform fast simulations on typical desktop environments such as spreadsheets.

For these simulations, the process of sparse stochastic roll-up may greatly reduce both the quantity of data and computation required. Furthermore, sparse stochastic roll-up may be easily implemented in commonly available desktop software. In the example below, it reduces the computation and data storage by a factor of roughly 1,000. Sparse notation for arrays, most of whose elements are zero, has been used in the past for storing mathematical matrices and graphics. This disclosure allows sparse storage and computation to be extended to the area of simulation.

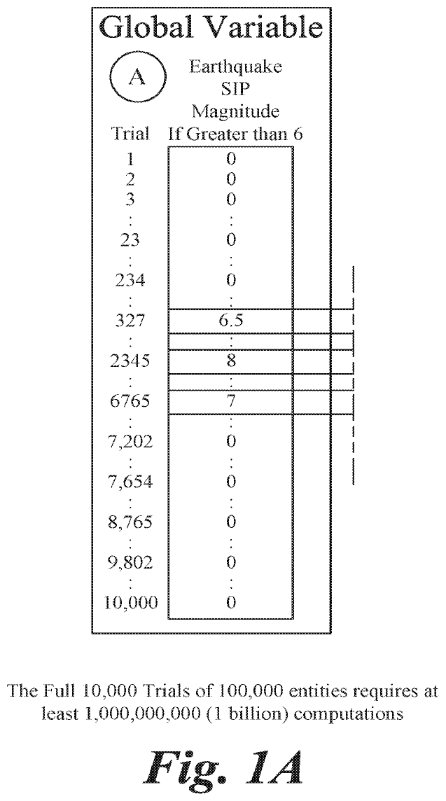

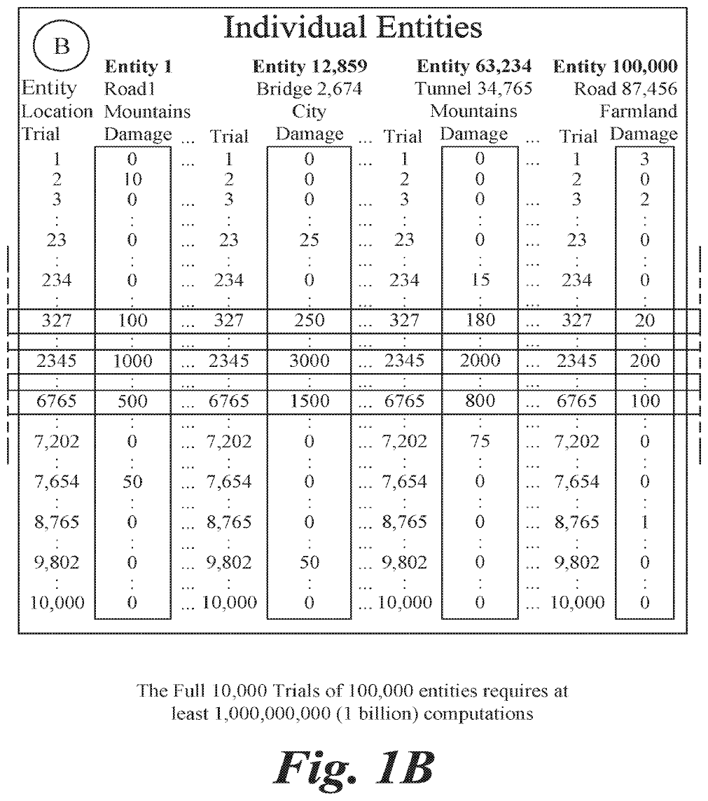

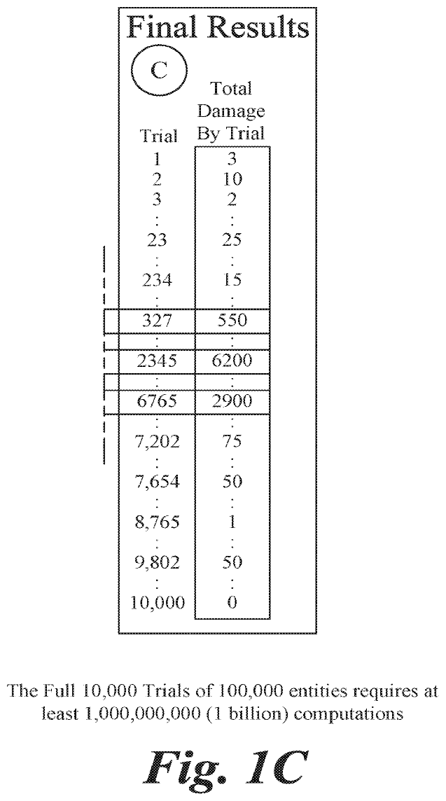

FIGS. 1A, 1B, and 1C (collectively referred to as FIG. 1) illustrate the elements of the simulation of the damage occurring to highway infrastructure due to global uncertainties such as an earthquake, and the natural deterioration of individual entities. Note that many more assets are included, of which only Roads 1 and 87,456, Bridge 2,674, and Tunnel 34,765 are illustrated.

### The Traditional Simulation Approach

Using traditional simulation, all the elements of FIG. 1 would be calculated sequentially from Trial 1 to Trial 10,000 within a single large computer program or application, according to the following steps.

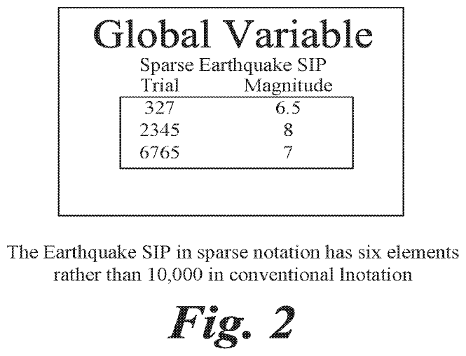

(1A) For each trial, the global variable(s) (earthquake magnitude in this example) is simulated first because if a simulated earthquake occurs it will effect some or all of the other elements (shaded rows). Note that earthquakes of consequence are very rare and only occur 3 times. Nonetheless, in traditional simulation, all 10,000 trials must be computed. That is, 10,000 random numbers would be generated representing potential projected earthquake magnitudes over the coming year. Most of these numbers would be zero, and many would be small magnitude, which would not cause damage within the simulated highway infrastructure. Only three of the 10,000 trials, 327, 2345 and 6765, are significant in that they are of magnitude 6 or greater, as shown in FIG. 2.

(1B) Once the global variable(s) is simulated for a given trial, the damage occurring to each of the 100,000 entities is simulated based on the global variable(s) outcome. That is, on trial 327 damage to each of the roads, bridges and tunnels would be simulated based on a magnitude 6.5 earthquake and that entity's distance from the epicenter. On any trial not involving an earthquake the damage due to idiosyncratic risk is simulated for each entity, but in this case there is very rarely any damage.

(1C) The sum of damage across all entities is then recorded as a trial in the final result. That is, for each of the 10.000 trials, damages across all 100,000 entities are summed even though most have no damage.

A simulation of this size requires several calculations to generate the random numbers for each of the 100,000 entities for each of the 10,000 trials shown in FIG. 1. That is, several billion calculations would be required to generate the random numbers, whereupon the 100,000 results for each trial would be summed for each of the 10,000 trials resulting in 1 billion additions. In traditional simulation, this is all performed at once in specialized software by a very powerful computer.

### The Probability Management Approach

Using probability management techniques, the global variables and separate entities may be simulated separately, possibly on different computers, with their results stored as SIPs (e.g., the outlined columns in FIG. 1). The steps for this approach may include the following.

(1A) The SIPs of global variables are simulated first and stored for later use as inputs to the remaining simulations. That is, all 10,000 earthquake magnitudes would be generated as before, even though most are zero. Unlike traditional simulations, the results would now be stored in a database for later use in the simulations of the individual entities.

(1B) The SIPs of the entities may be simulated and stored individually, possibly on different machines and in different software environments. The trials are based on the global SIP(s) created in step 1 and read or accessed from the earthquake database. Idiosyncratic risk is also simulated. The 100,000 SIPs of 10,000 trials would then be stored in a database for the entities.

(1C) The sum of damage across all entities is found for each trial of the simulation by retrieving the entity SIPs from the entity database and summing (rolling-up) the results of the individual entities trial by trial to arrive at the final result.

The probability management approach has the advantage of breaking a large potentially intractable simulation into small simulations that may be run separately. This represents a significant breakthrough in simulation. However, it requires the storage of large amounts of data, 1 billion numbers in this case.

### Sparse Stochastic Roll-Up

A sparse stochastic roll-up technique is built upon the probability management approach, but only calculates the non-zero elements of the simulation as follows. We assume that the number of trials (iMax) that is adequate for the desired simulation fidelity is 10,000.

The sparse stochastic roll-up technique may include estimating the probability distribution of external risk drivers for a given risk category. External risk drivers are factors that exist globally and affect the system uniformly on any trial in which they occur. An example of an external risk driver is an earthquake, flood, or act of terror. In this example, the risk of a magnitude 6 or greater earthquake per 10,000 trials is mMax=3. Instead of generating 10.000 trials all but three of which are zero, Generate mMax=3 unique random integers between 1 and 10,000, to indicate the trials where an earthquake occurs. This is a key advantage of the process as it reduces 10,000 simulation trials to 3 trials.

### Simulate the Associated Earthquake Magnitudes.

In some aspects, the three trial numbers E(m), m=1 . . . 3, may be stored along with their associated magnitudes, as shown in FIG. 2. Thus for this example, the information in the 10,000 trial earthquake SIP is now stored in six numbers, where trial numbers E(1)=327, E(2)=2345, and E(3)-6765 are accompanied by the associated magnitudes.

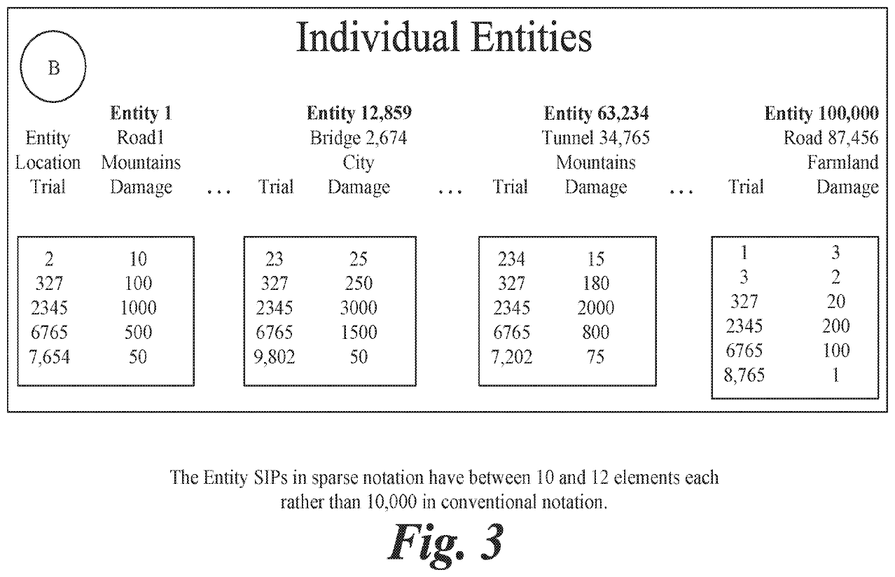

For each of the entities or assets (entity, k=1 . . . 100,000) to be stored in Sparse Monte Carlo notation, we store only the trial numbers and outcomes for significant events. FIG. 3 illustrates the entity SIPs in sparse notation. In some aspects, the simulations for individual assets can be performed on different computers using different software contingent upon using a common earthquake SIP.

In some aspects, nMax unique random integers between 1 and 10,000 may be generated to indicate the trials where an event occurs. This is a key advantage of the process as it reduces the total simulation trials, iMax (10,000 in this embodiment) to nMax trials, where for rare events nMax will be much less than iMax.

In some aspects, the associated impact may be simulated for all trials for which there are global events (earthquakes on trials 327, 2345, 6765) and any idiosyncratic risk events (trials 2 and 7,654 for Entity 1). Attached to the trial numbers are damage impacts given an event (expressed in dollars or other units relevant to the event) which are drawn from the appropriate probability distributions.

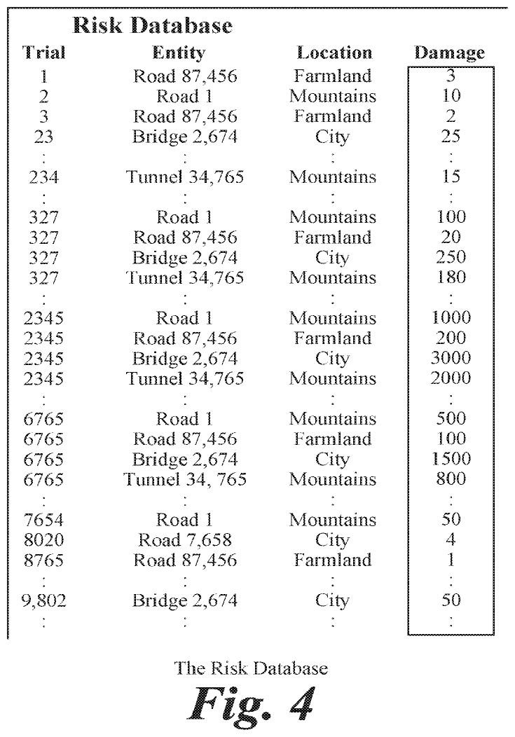

In some aspects, all entity results may be stored in a risk database, for example, as illustrated in FIG. 4, for later roll-up. Each row in FIG. 4 is an event involving some entity, and displays both the damage impact of the event and the trial number at which that event occurred. At this stage, there may be duplicate trial numbers in case an event occurred on more than one entity on a given trial. Note that the full risk database would contain many other assets.

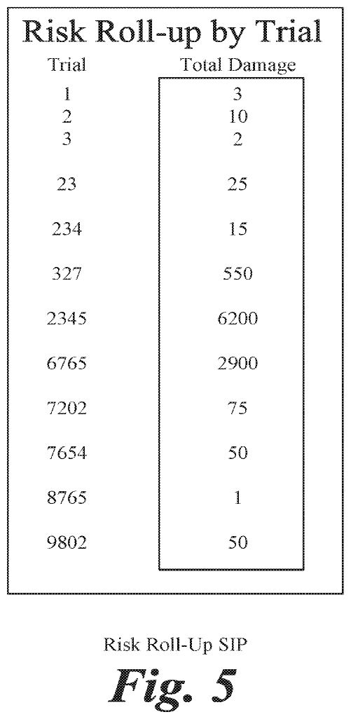

Once the Risk Database has been constructed, modern database or Business Intelligence software such as Microsoft PowerBI or PowerPivot can be used according to this disclosure to aggregate the damage impacts for each represented trial. For example, suppose that on trial 1 of the simulation, only 10 of the 100,000 entities had damage. Then these ten trials would be extracted from the database and summed, instead of summing 100,000 numbers, most of which would be zero. Many trials will not be represented for each entity, as no event will have occurred for that trial, so this does not involve 100,000 calculations per trial. The resultant SIP represents the total distribution of damage impacts given that there was damage. We refer to this as a Risk Roll-up, as illustrated in FIG. 5, which corresponds to the last column of FIG. 1, but was accomplished entirely using sparse notation. FIG. 5 includes only the trials in which a risk event occurs, and for those trials, the total risk of all assets is summed.

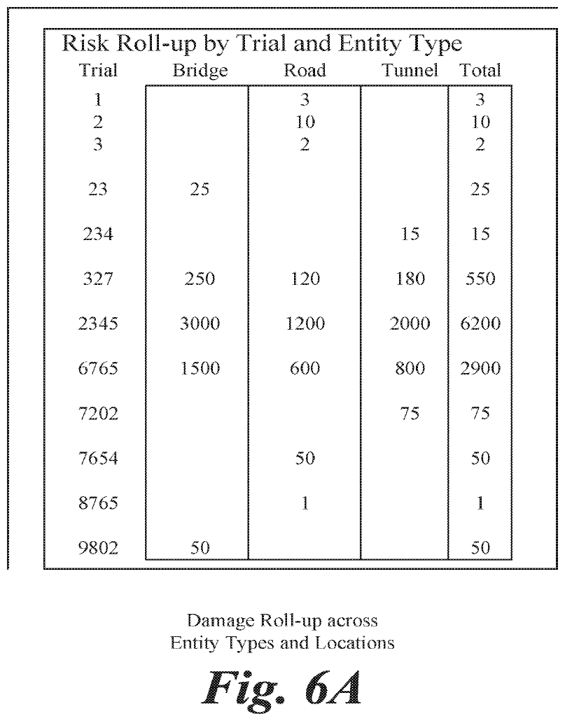

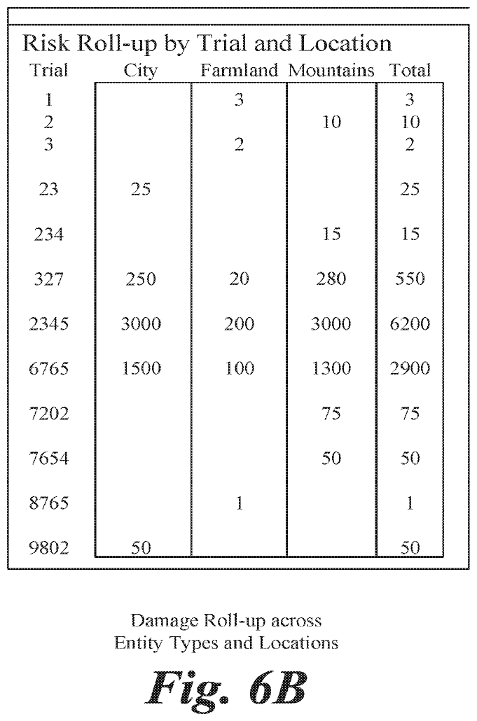

In some aspects, the Risk Database may be quickly rolled up by selecting only those trials from the database corresponding to user specified criteria, such as displaying conditional SIPs for the total damage across types of entity or location, as shown in FIGS. 6A and 6B.

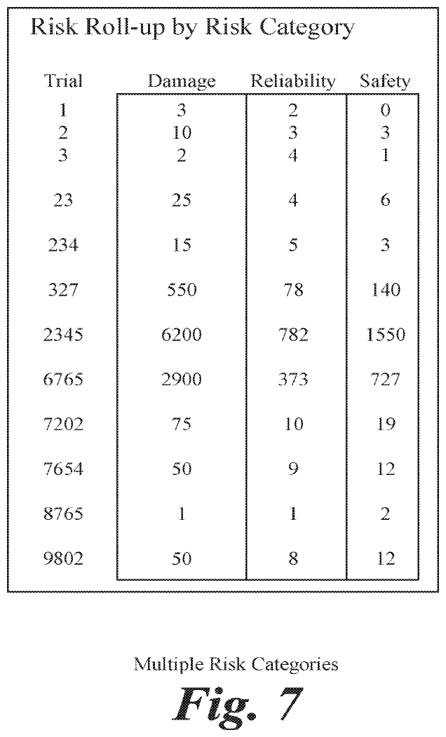

In some cases, there are various categories of risk, which must be judged separately. External risk drivers maintain coherence across all risk categories. The resulting set of coherent, rolled-up SIPs of various categories can be compared from a multi-attribute utility perspective. For example, one could specify relative weights for injuries, reliability, etc., or apply other methods to guide decision making, an example of which is illustrated in FIG. 7.

### Non-Congruent SIP Libraries

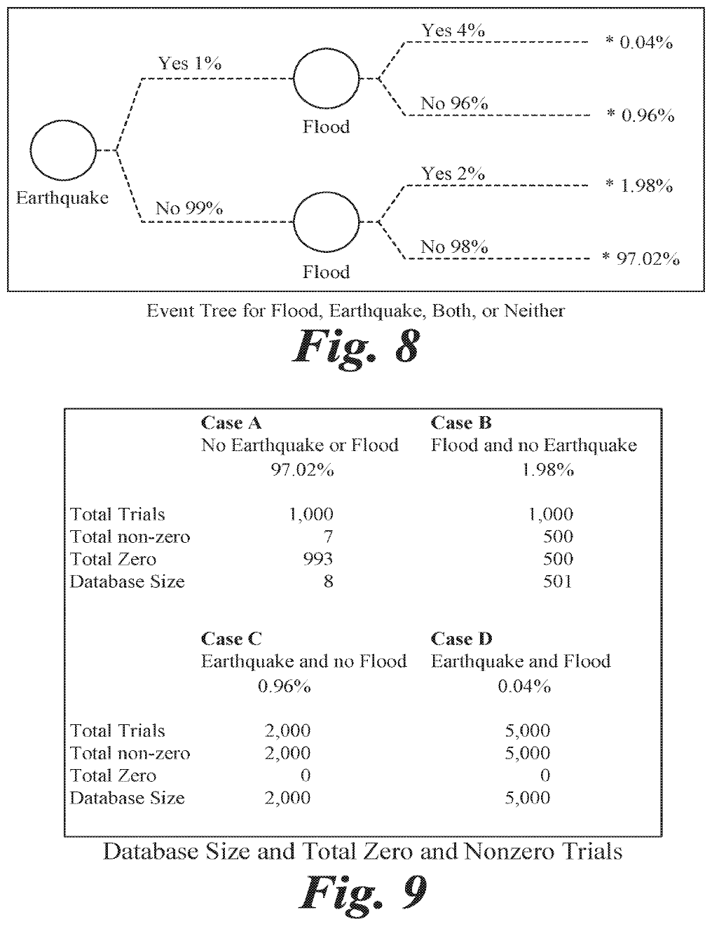

In a fourth application of the described techniques, power grid reliability risk for the upcoming year or other period of time may be assessed in the face of possible earthquake, flood, both, or neither. An event tree used for this example is shown in FIG. 8.

The chance of an earthquake occurring is 1%. If an earthquake doesn't occur, the chance of a flood is 2%. However, if an earthquake does occur, then the chance of the flood is raised to 4%. Thus, by multiplying the probabilities for each combination, we find that the likelihood of no earthquake and no flood is 97.02% (case A), the likelihood of no earthquake and a flood is 1.98% (case B), the likelihood of an earthquake but no flood is 0.96% (case C), and the likelihood of both an earthquake and flood is 0.04% (case D).

The power grid in this example provides electricity to a large customer base, and its reliability risk is measured in terms of hours of outage across the system. Each of the four mutually exclusive cases causes a different set of impacts. The number of trials run for each case may be different, and is dependent on the level of granularity needed to properly assess the impacts associated with that case. For example, if there is no earthquake, outages are relatively short without much variation, so a smaller number of trials is required. With an earthquake there would be a wider range of outcomes and more trials would be required to capture the range of uncertainty, as shown in FIG. 9. The range of outcomes that the simulation produced for case D was wide enough that 5000 trials were decided appropriate. Similarly, the rarity of any outage in case A necessitated 1000 trials to get a reasonable sample pool of outages.

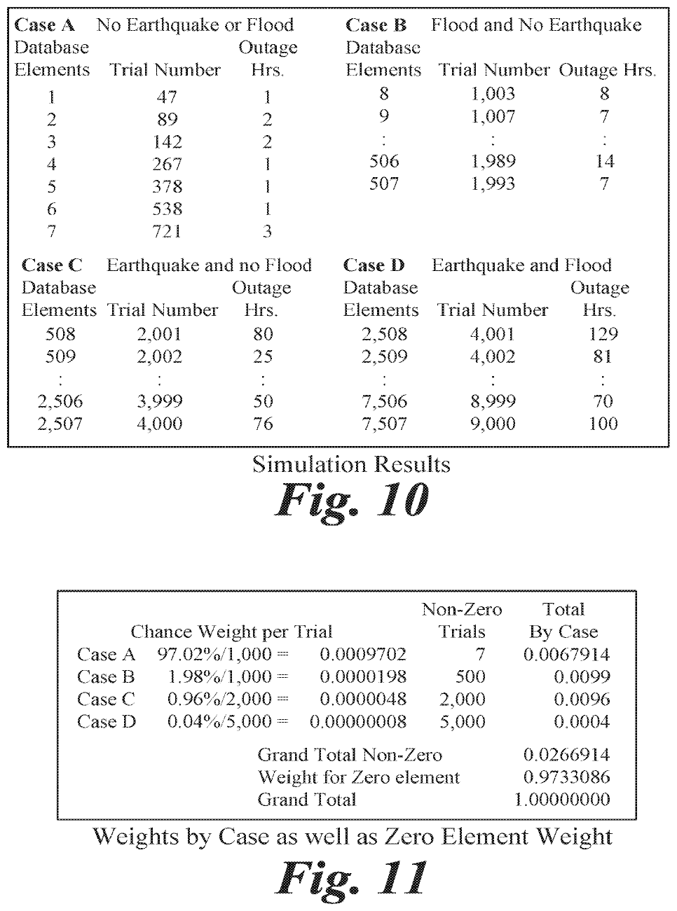

In case A, where no external event happens, it is rare that any hours of outage are experienced. In 1000 simulated trials, only 7 had any outage, and the time spent without power was brief, with a maximum of 3 hours. A detailed example of the trials corresponding to the occurrence of an event in each case is illustrated in FIG. 10. The probability weighting of each trial is the likelihood of case A (97.02%) divided by the number of trials run (1000), as illustrated in FIG. 11. In this case, the remaining 993 trials have a value of 0, and case A is stored sparsely as 7 database entries, one for each trial of outage. In terms of the total simulation across the four cases, 97.3% is valued at 0.

In case B, where the external event was a flood, 1000 trials were run. Five hundred trials exhibited a non-zero outage, but the outages weren't particularly long, as illustrated in FIG. 10. The probability weighting of each trial is the likelihood of case B (1.98%) divided by the number of trials run (1000). In this case, the remaining 500 trials have a value of 0, and case B is stored sparsely as 500 database entries.

In case C, where the external event was an earthquake, 2000 trials were run. Every trial exhibited an outage, and the outages were of moderate length, as illustrated in FIG. 10. The probability weighting of each trial is the likelihood of case C (0.96%) divided by the number of trials run (2000).

In case D, where both a flood and an earthquake occurred, 5000 trials were run. Every trial exhibited an outage, and the outages were of severe length, as illustrated in FIG. 10. The probability weighting of each trial is the likelihood of case D (0.04%) divided by the number of trials run (5000).

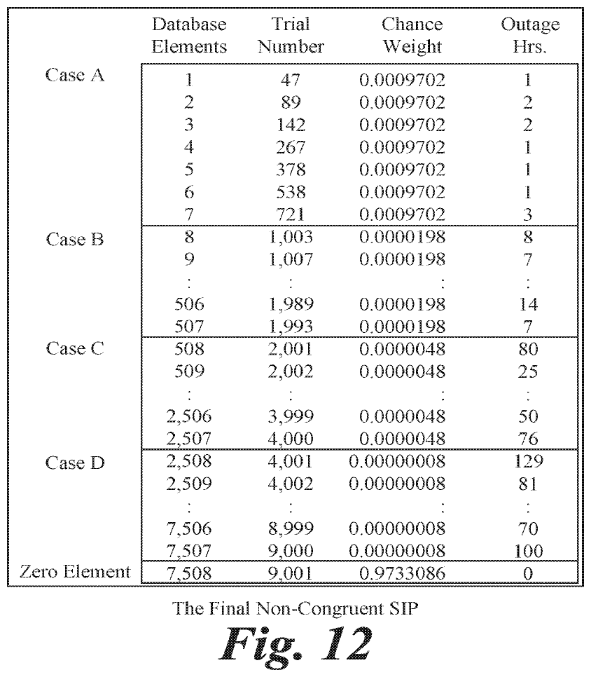

The final non-congruent SIP, shown in FIG. 12, contains all 7508 database elements, each of which has a Trial Number, a Chance Weight, and an Impact expressed in outage hours. All of the zeroes are stored in a single database entry, which is weighted by subtracting the total nonzero weights from 1, as shown in FIG. 12. That is, at any of the trials, the Chance Weight provides the chance that event will happen while the Outage Hours specify how long that outage would be.

### Aggregating and Comparing Investment Portfolios

A fifth application of the described techniques enables an investor to instantly simulate the projected risks and returns resulting from changing the assets in their portfolio by aggregating SIPs of financial performance.

The system in this example consists of a stochastic database which stores coherent SIPs representing future uncertain returns of a large number of stocks, bonds and other financial instruments including low probability events. The system also stores each user's current portfolio. An interface may be provided that allows the user to add or remove assets from the portfolio and instantly simulate and view the risk and return results.

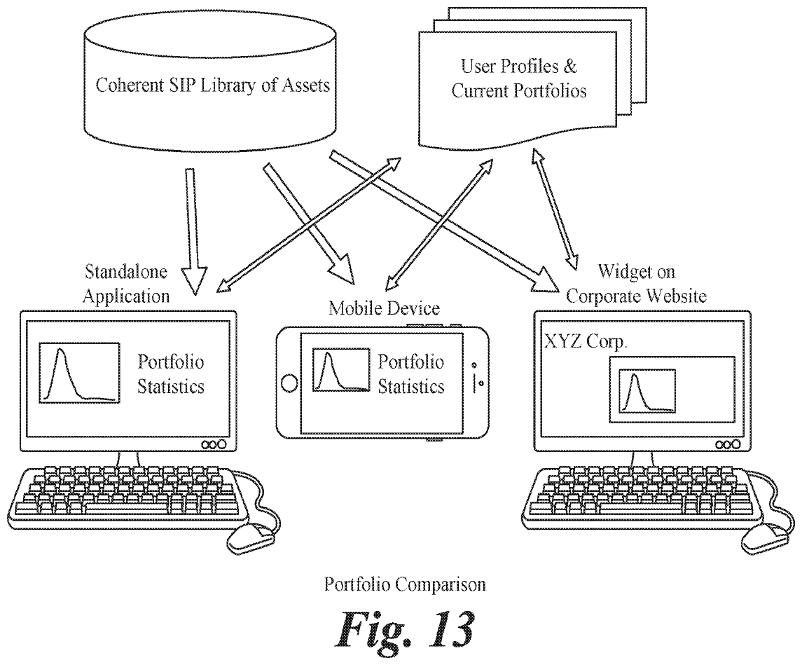

In one example, as illustrated in FIG. 13, the interface is a devoted web application, program on the user's computer, or other application running on any computing device, such as a tablet, laptop, etc. In a second example, the user interface is on a mobile device. In a third example, the interface is a widget installed on the investment relations page of a publicly traded firm. Here, the user assesses the risk and return consequences of adding that firm's stock to their portfolio, or swapping it out for other assets.

The described systems and methods may be implemented on any of a number of computing devices, which may interface with local or remote memory to store, access, and/or modify data, such as simulations, outcomes, and other information.

### Risk Measures, Mitigation, Optimization

Many risk models use average results because averages may be aggregated across the enterprise. That is, the average of total damage across a set of ten bridges, for example, can be rolled up by summing the average damage of each of the ten bridges. However, the average is a poor risk measure and leads to a set of systematic errors called the Flaw of Averages. Better risk measures, such as the 90th percentile (a damage that will be exceeded only 10% of the time) may not be aggregated. That is, the 90th percentile of total damage across a set of ten bridges cannot be rolled up by mathematically summing the 90th percentiles of damage of each of the ten bridges. This is a consequence of the laws of probability that govern multiple uncertainties. Consider an example of two random die rolls added together. The 83^{rd} percentile of each die roll is 5. That is, each die will only exceed 5, 17% or one sixth of the time. If we sum the 83^{rd} percentiles of both dice, we get 5+5=10. However, 10 is not the 83^{rd} percentile of the sum of two dice. The chance that the sum of two dice will exceed 10 is 1/36^{th} (the chance of 12)+ 2/36^{ths} (the chance of 11)= 3/16^{ths}=8%. Therefore, the chance of two dice summing to 10 or less is 92% not 83%. However, SIPs may be added together whereupon the percentile may be taken of the sum. That is, the SIPs of the damage of each bridge may be summed first, element by element, and the 90th percentile, or any other statistic derived from the summed SIP. This ability to aggregate or roll up individual simulations is why the discipline of probability management represents a breakthrough in modeling risk as described in Probability Management. Sam Savage, Stefan Scholtes and Daniel Zweidler, OR/MS Today, February 2006, Volume 33 Number 1.

### Mitigation

In one embodiment of the described techniques, there are several strategies to mitigate the risk across the entities. The risks may include, for example, more frequent inspections, changing traffic flow, or maintenance of various sorts. Because, as described above, risks cannot be simply summed up, we cannot add up the risk reduction for each asset for each mitigation. Probability management allows the creation of a separate SIP for each entity for each mitigation strategy. Then, for each mitigation, the SIPs of all entities may be summed. If there were, for example, five mitigation strategies, then=the total risk under each mitigation can be calculated by comparing the 90^{th} percentiles of each of only five SIPs, one for each strategy.

### Optimization

SIPs are ultimately useful as the inputs to stochastic optimization methods. For example, once risk measures are determined, optimization using the SIP data can be performed to find efficient tradeoffs between cost and risk, or between different risk measures. This can also be performed to find such tradeoffs between reward and risk as described in Probability Management, Sam Savage, Stefan Scholtes and Daniel Zweidler, OR/MS Today. February 2006, Volume 33 Number.

FIG. 13 shows a risk roll-up dashboard system that aggregates various risks based on a SIP library, and determines the optimal portfolio of mitigations for different cost budgets. This may be accomplished in native Microsoft Excel, using the built in Data Table and Solver commands using the methods described in Holistic vs. Hole-istic Exploration and Production Strategies, Ben C. Ball & Sam L. Savage, Journal of Petroleum Technology. September 1999, the contents of which are herein incorporated by reference in their entirety.

A set of potential mitigations appears in the upper right of the dashboard. The portfolio of mitigations being considered includes investing in 22% of the total possible nuclear storage risk mitigation program, 50% of a sea wall mitigation, and 20% of a physical security program. In other situations, the fractional application of a mitigation would not be possible, and each mitigation would be invoked on an all or nothing basis.

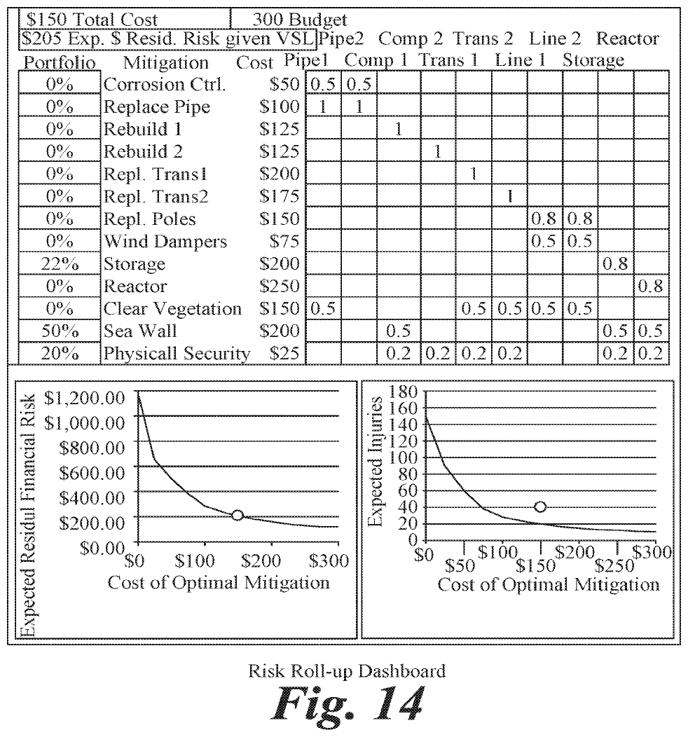

The graph illustrated on the lower left of FIG. 14 shows the minimum residual (remaining) financial risk for various mitigation budgets. The large dot shows that the current mitigation portfolio, with a budget of $150 million, is “efficient” in that it is on the line representing the optimal tradeoff between cost and financial risk, resulting in expected financial risk of $205 million.

The graph on the lower right of FIG. 14 displays the residual safety risk in expected injuries, for the current mitigation portfolio. Note that it is not efficient. That is, a different portfolio of mitigations could further lower the expected injuries at this budget level.

Various stakeholders with differing risk attitudes can adjust the mitigation portfolio in real time and see the results of 10,000 stochastic trials per keystroke, allowing for risk-informed judgment on the portfolio level. This allows joint decisions to be arrived at through negotiation instead of litigation.

Such risk roll-up systems are not possible without SIP libraries, and the sparse risk-roll up approach makes it practical to generate SIP libraries from a large number of simulation trials with rare risk events.

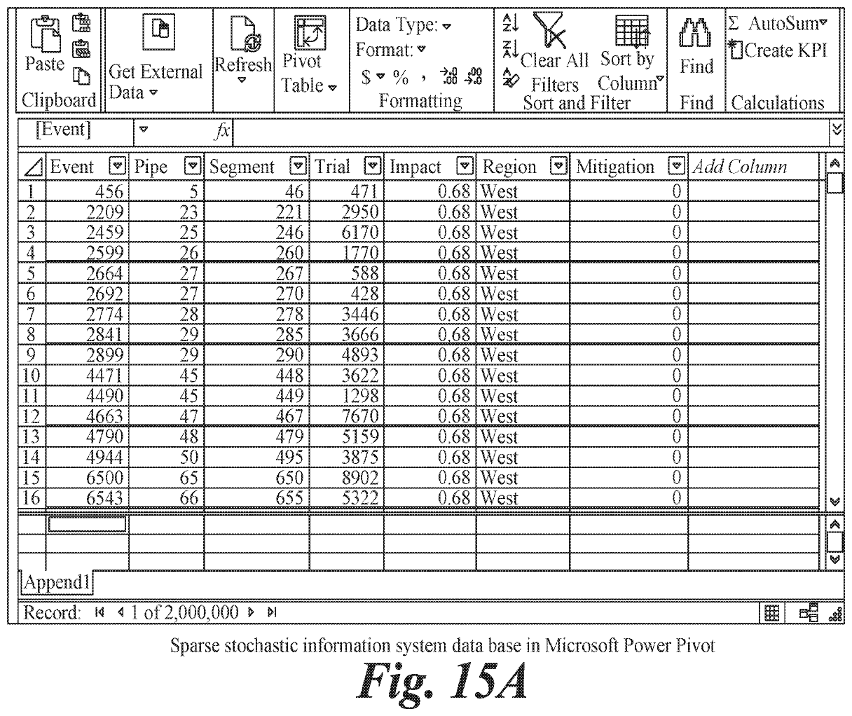

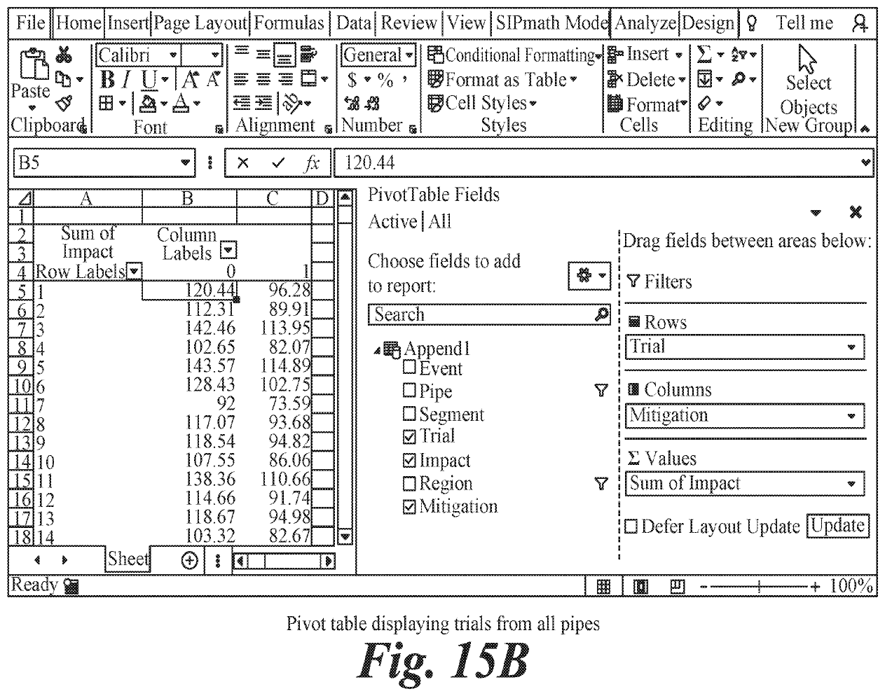

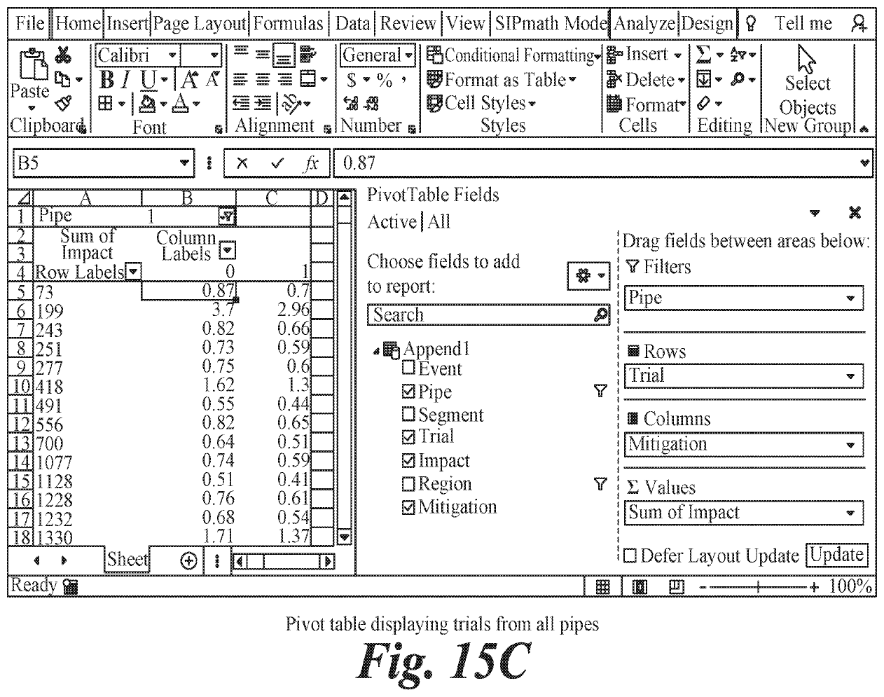

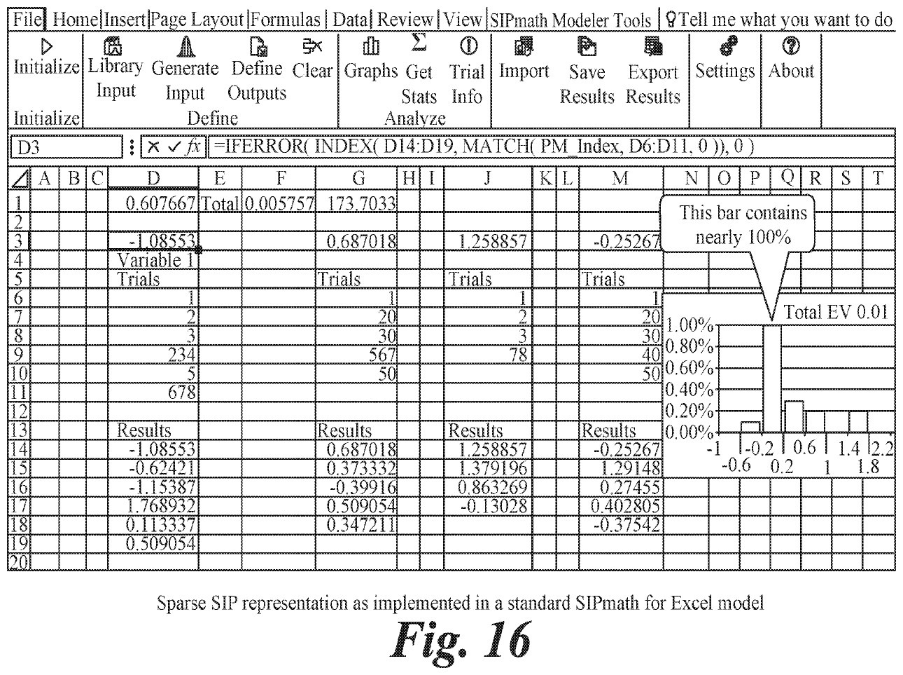

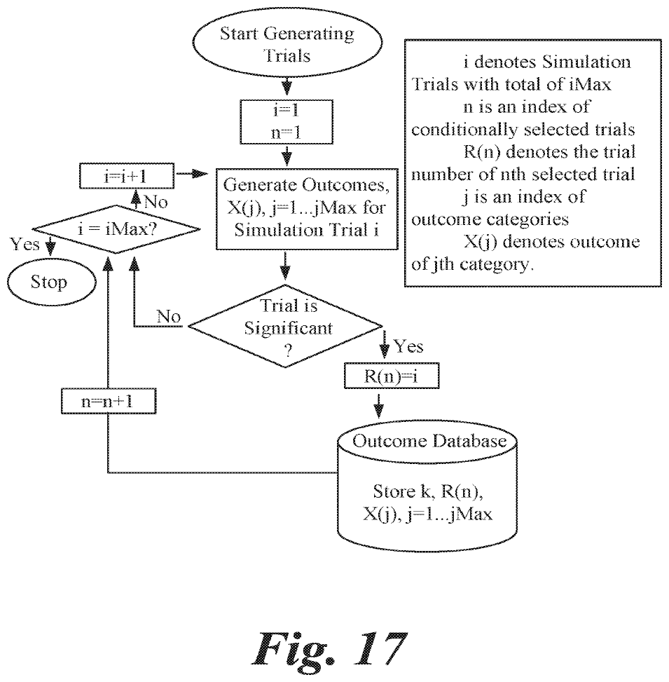

In one example, the Sparse Stochastic Roll-up methodology can be implemented and programmed into in Microsoft PowerPivot. As shown in FIG. 15A, large libraries of sparse SIPs can be stored within Microsoft Excel's data model. Using PowerPivot, the sparse SIPs can be viewed as Pivot Tables, as illustrated in FIGS. 15B and 15C. Sparse SIPs can be represented and implemented in Excel SIPmath models with full compatibility with the SIPmath modeler tools, as illustrated in FIG. 16. Additionally, Sparse Stochastic Roll-up can be performed algorithmically using any standard programming language.

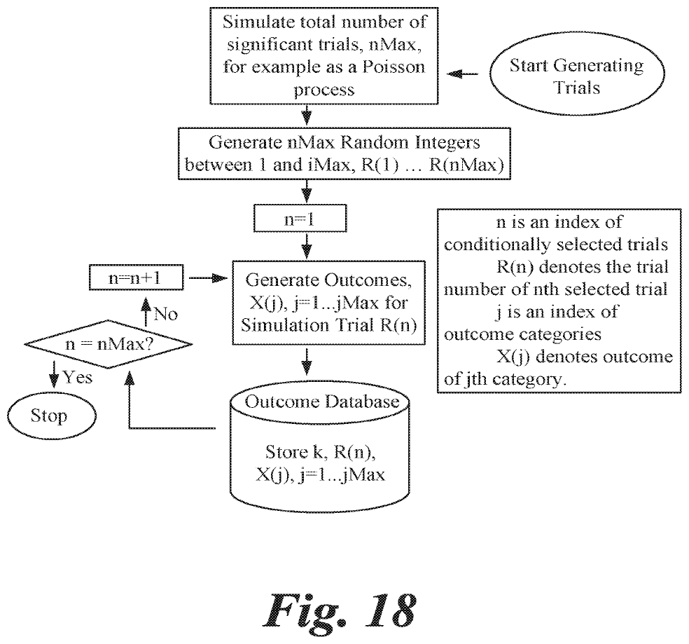

FIG. 17 illustrates an example method for generating all risk outcomes for a given asset, denoted A(k), and storing significant outcomes. In one example, the trials of the stochastic simulation may be stored in a database, where each entry of the database contains a trial number of the stochastic simulation and additional information associated with that trial, such that the trials in the database are the various outputs of the simulation. The variables referenced in this flowchart are the following: k is the index of all assets to be simulated where the largest value is kMax, A(k) denotes the k^{th} asset in the simulation, i denotes simulation trials where the largest value is iMax, n is an index of conditionally selected trials where the largest value is nMax, R(n) denotes the trial number of the n^{th} selected trial, j is an index of outcome categories where the largest value is jMax, and X(j) denotes the outcome of the j^{th} category.

The process of trial generation begins with (1) initializing the variables i and n by setting their values to 1. Next comes the process of (2) generating the outcomes of the simulation for the current trial i, denoted as X(j) for all categories of j from 1 to jMax. Next, (3) a decision is made about whether or not the trial is significant. If yes:
a Set R(n) equal to i
b. Store k, R(n), and X(j) for the values of j from 1 to jMax in the outcome database
c. Set n equal to n+1
d. Proceed to step 4

If no, (4) check if i is equal to iMax. If no, set i equal to i+1 and return to step 2. If yes, (5) the simulation is complete for asset A(k).

FIG. 18 illustrates an example method for generating and storing significant outcomes for a given asset, denoted A(k). In one example, each entry of the database contains a trial number of the stochastic simulation and additional information associated with that trial, such that the trials in the database are the various outputs of the simulation for that trial. The variables referenced in this flowchart are the following: k is the index of all assets to be simulated where the largest value is kMax, A(k) denotes the k^{th} asset in the simulation, i denotes simulation trials where the largest value is iMax, n is an index of conditionally selected trials where the largest value is nMax. R(n) denotes the trial number of the n^{th} selected trial, j is an index of outcome categories where the largest value is jMax, and X(j) denotes the outcome of the j^{th} category.

The process of trial generation begins with (1) simulating the total number of significant trials, nMax, in a chosen manner, i.e. as a Poisson process. Next, (2) generate nMax random integers between 1 and iMax, stored as R(1) through R(nMax). Next, (3) initialize the variable n by setting its value to 1. Next comes the process of (4) generating the outcomes of the simulation for the current trial R(n), denoted as X(j) for all categories of j from 1 to jMax. Next, (5) Store k, R(n), and X(j) for the values of j from 1 to jMax in the outcome database. Next, (6) check if n is equal to nMax. If no, (7) set n equal to n+1 and return to step 4. If yes, (8) the simulation is complete for asset A(k).

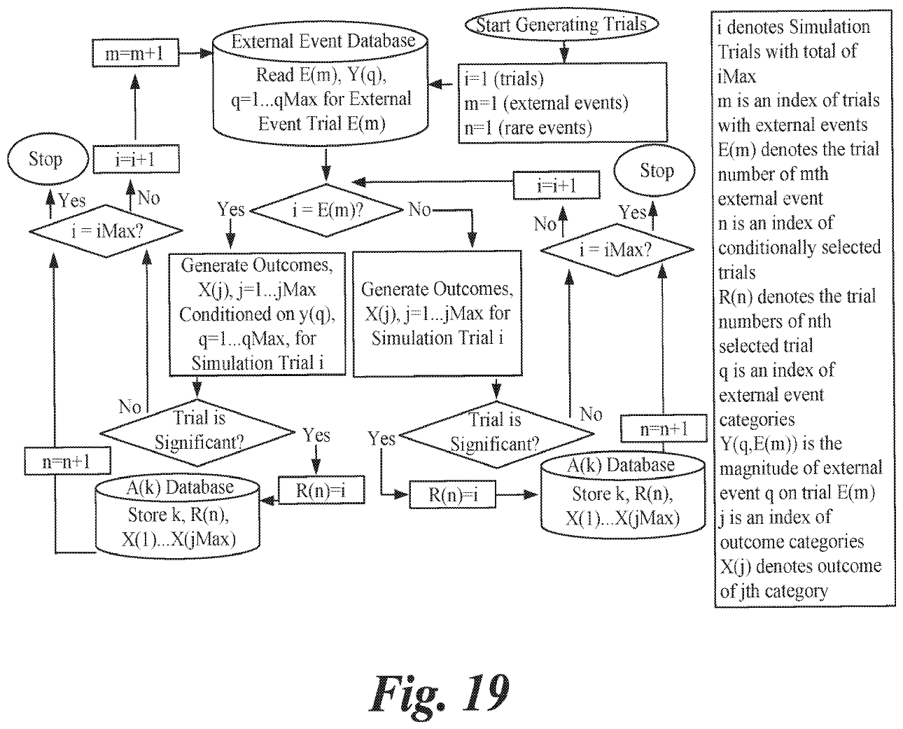

FIG. 19 illustrates an example method for generating all risk outcomes for a given asset, denoted A(k), conditioned on a database of external events which may affect the asset A(k), and storing significant outcomes. The variables referenced in this flowchart are the following: k is the index of all assets to be simulated where the largest value is kMax, A(k) denotes the k^{th} asset in the simulation, i denotes simulation trials where the largest value is iMax, m is an index of trials with external events, E(m) denotes the trial number of the m^{th} external event, n is an index of conditionally selected trials where the largest value is nMax. R(n) denotes the trial number of the n^{th} selected trial, q is an index of external event categories, Y(q) is the magnitude of the q^{th} external event, j is an index of outcome categories where the largest value is jMax, and X(j) denotes the outcome of the j^{th} category.

The process of trial generation begins with (1) initializing the variables i, n, and m by setting their values to 1. Next, (2) read E(m) and Y(q) for the values of q from 1 to qMax from an external event database. Next, (3) check if i is equal to E(m). If yes:
a. Generate the outcomes of the simulation for the current trial i, denoted as X(j) for all categories of j from 1 to jMax, conditioned upon the external events Y(q) for all categories of q from 1 to qMax
b. Decide whether or not the trial is significant. If no, proceed to step c. If yes:
i. Set R(n) equal to i
ii. Store k, R(n), and X(j) for the values of j from 1 to jMax in the outcome database
iii. Set n equal to n+1
iv. Proceed to step c
c. Check if i is equal to iMax. If yes, the simulation is complete for asset A(k). If no:
i. Set i equal to i+1
ii. Set m equal to m+1
iii. Return to step 2

As a continuation of step 3, check if i is equal to E(m). If no:
a. Generate the outcomes of the simulation for the current trial i, denoted as X(j) for all categories of j from 1 to jMax
b. Decide whether or not the trial is significant. If no, proceed to step c. If yes:
i. Set R(n) equal to i
ii. Store k, R(n), and X(j) for the values of j from 1 to jMax in the outcome database
iii. Set n equal to n+1
iv. Proceed to step c
c. Check if i is equal to iMax. If yes, the simulation is complete for asset A(k). If no:
i. Set i equal to i+1
ii. Return to step 3

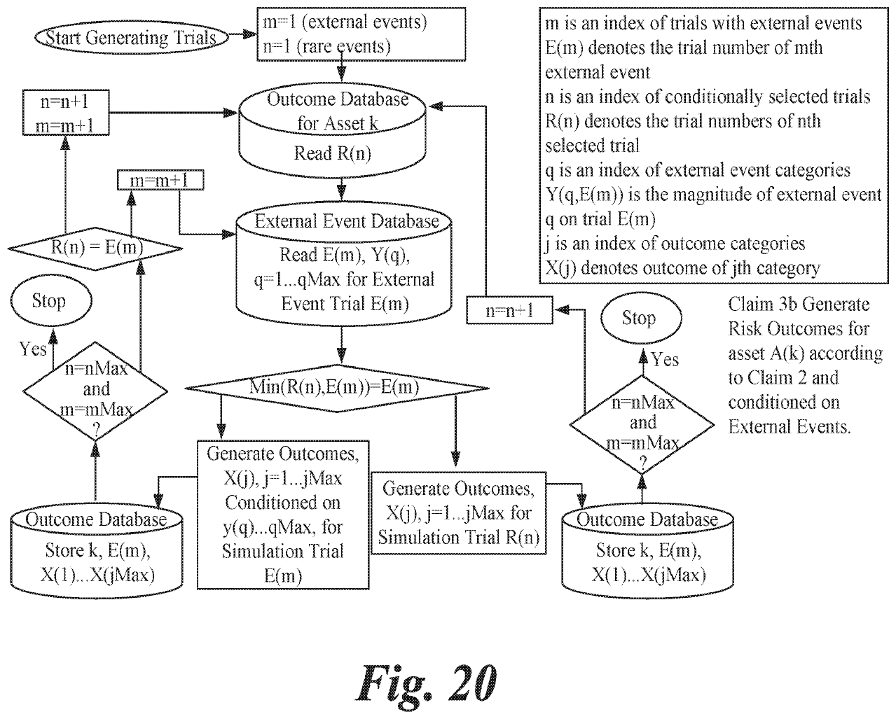

FIG. 20 illustrates an example method for generating and storing significant outcomes for a given asset, denoted A(k), conditioned on a database of external events which may affect the asset A(k). The variables referenced in this flowchart are the following: k is the index of all assets to be simulated where the largest value is kMax, A(k) denotes the k^{th} asset in the simulation, m is an index of trials with external events, E(m) denotes the trial number of the m^{th} external event, n is an index of conditionally selected trials where the largest value is nMax, R(n) denotes the trial number of the n^{th} selected trial, q is an index of external event categories, Y(q) is the magnitude of the q^{th} external event, j is an index of outcome categories where the largest value is jMax, and X(j) denotes the outcome of the j^{th} category.

The process of trial generation begins with (1) initializing the variables n and m by setting their values to 1. Next, (2) read R(n) from an outcome database for A(k). Next, (3) read E(m) and Y(q) for the values of q from 1 to qMax from an external event database. Next, (4) check if the minimum of R(n) and E(m) is equal to E(m). If yes:
a. Generate the outcomes of the simulation for the current trial E(m), denoted as X(j) for all categories of j from 1 to jMax, conditioned upon the external events Y(q) for all categories of q from 1 to qMax
b. Store k, E(m) and X(j) for the values of j from 1 to jMax in the outcome database
c. Check if both n equals nMax and m equals mMax. If yes, the simulation is complete for asset A(k). If no:
i. Check if R(n) equals E(m). If yes:
   1. Set n equal to n+1
   2. Set m equal to m+1
   3. Return to step 2

As a continuation of step i, check if R(n) equals E(m). If no:
1. Set m equal to m+1
2. Return to step 3

As a continuation of step 4, check if the minimum of R(n) and E(m) is equal to E(m). If no:
a. Generate the outcomes of the simulation for the current trial R(n), denoted as X(j) for all categories of j from 1 to jMax
b. Store k, R(n) and X(j) for the values of j from 1 to jMax in the outcome database
c. Check if both n equals nMax and m equals mMax. If yes, the simulation is complete for asset A(k). If no:
i. Set n equal to n+1
ii. Return to step 2

### Conditional Generation and Storage of Vectors of Simulation Realizations

In some aspects, one or more of the above-described systems and methods may be captured by one or more of the following additional concepts. One or more of the following concepts may be combined with one or more other concepts, either listed below or described above, as will be appreciated by one having ordinary skill in the art.

A system/method for generating and/or storing trial outcomes of a stochastic simulation, wherein the outcomes are selected or weighted according to user specified criteria while preserving statistical relationships between variables. For example, in simulating the structural failure of multiple bridges in a highway system, the user might specify that only those trials with failures be generated and/or saved.

The system/method as described above, for generating and/or storing outcomes and the associated trial numbers of a stochastic simulation in a database, where each entry of the database contains a trial number of the stochastic simulation and additional information, such as the simulated outputs of various risk or reward categories associated with that trial, such that the trials in the database are the various outcomes of the simulation, wherein all simulation trials are performed but only significant trials are stored. See FIG. 17.

The system/method as described above, for generating only those trials on which a significant event occurs, then storing them in a database, where each entry of the database contains a trial number of the stochastic simulation and additional information associated with that trial, such that the trials in the database are the various outcomes of the simulation. See FIG. 18.

The system/method as described above, for generating outcomes of a stochastic simulation conditioned on external events per claim 2. See FIG. 19.

The system/method as described above, for generating outcomes of a stochastic simulation conditioned on external events per claim 3. See FIG. 20.

The system/method as described above, for generating and/or storing outcomes of a stochastic simulation in a database, where each entry of the database contains a chance weight associated with each trial number of the stochastic simulation and additional information associated with that trial, such that the sum of all chance weights equal 1. See FIG. 12.

The system/method as described above, for generating and/or storing outcomes of a stochastic simulation in a database, where each entry of the database contains a chance weight associated with each trial number of the stochastic simulation and additional information associated with that trial, such that the sum of all chance weights equal 1, and the weights are calculated from a symbolic representation of events, such as a fault tree or probability tree. See FIG. 8.

The system/method as described above, for generating outcomes of a stochastic simulation interactively in real time.

The system/method as described above, for storing outcomes of a stochastic simulation that were generated from existing simulation software.

### Aggregating Conditionally Generated Stochastic Information Packets

A system/method for combining two or more SIPs representing a single simulated output generated according to claim 1 into a single SIP. See FIGS. 10, 11, and 12. In some aspects, this example may further include communicating and handling information formatted by XML, comma separated values, JSON, text values, and other digital file formatting. Further explanation of SIPs and example processes for handling SIPs are described in the attached Appendix A.

A system/method for aggregating two or more SIPs representing different simulated outputs generated, into a single SIP representing the sum of the outputs wherein statistical relationships are preserved. See FIG. 5.

A system/method for aggregating two or more SIPs representing different simulated outputs generated, as described above, into a single SIP representing the sum of the outputs.

Some aspects may further include the incorporation of stochastic optimization applied to portfolios of risk mitigations or risky projects to create optimal risk/cost or optimal risk/reward tradeoff curves. In some cases, this example may further include the interactive and near real-time updating of information. In vet some cases, this example may also include communicating with native and non-native optimization tool-kits and application software.

Some aspects may include simulating the future uncertain returns and other information resulting from modifying the set of assets in their investment portfolio by aggregating SIPs of financial performance stored in a database. In some cases, this example may further include the interactive and near real-time updating of information. In yet some cases, this example may also include generating and/or storing trial outcomes of a stochastic simulation, wherein the outcomes are selected or weighted according to user specified criteria while preserving statistical relationships between variables. In some cases, this example may include communicating stochastic information or analysis results through any number of web, mobile and digital interfaces.

While various aspects of the present disclosure have been illustrated and described, as noted above, many changes can be made without departing from the spirit and scope of the disclosure. Accordingly, the scope of the disclosure is not limited by the disclosure of the above examples. Instead, the bounds of the disclosure should be determined entirely by reference to the claims that follow.

What is claimed is:

1. A method for generating and storing trial outcomes of a stochastic simulation of an entity, the method comprising:
simulating a first number of simulation trials on any one of which an event can occur;
determining a second number of simulation trials for which the event occurs, wherein the second number is less than the first number;
associating at least one result value associated with the occurrence of the event with each of the second number of simulation trials; and
storing each trial and the associated at least one result value of each of the second number of the simulation trials as a record in a database, wherein the first database accurately represents all of the outcomes on which the event occurred out of the first number of simulation trials.

2. The method of claim 1, wherein the simulating, the determining, the associating, and the storing is performed for each of at least two entity's resulting in a plurality of records associated with a first entity and a second entity, wherein the method further comprises aggregating the at least one result value of the at least one record associated with the first entity with at least one result value of the at least one record with the second entity.
